(19) United States
(12) Patent Application Publication
(10) Pub. No.: US 2014/0252138 A1
(43) Pub. Date: Sep. 11, 2014

(54) Pressure Washer Adjustable Nozzle Assembly

(71) Applicant: GENERAC POWER SYSTEMS, INC., Waukesha, WI (US)

(72) Inventors: Greg Wischstadt, Wales, WI (US); Mir Khan, Kenosha, WI (US)

(73) Assignee: Generac Power Systems, Inc., Waukesha, WI (US)

(21) Appl. No.: 13/785,649

(22) Filed: Mar. 5, 2013

(51) Int. Cl. B05B 1/12

(52) U.S. Cl. CPC B05B 1/12
USPC 239/589; 29/428

(57) ABSTRACT

A nozzle assembly and method of forming an adjustable spray pattern nozzle assembly includes a mount body, a nozzle body, and a collar that movably cooperates with the mount body. The mount body is constructed to cooperate with a discharge end of a wand and such that the nozzle body can be captured between the mount body and the collar. The nozzle body defines an uninterruptible fluid flow path through the nozzle assembly. The nozzle assembly includes an interruptible fluid flow path that is defined by a positional relationship between the nozzle body and the collar. The collar movably cooperates with the mount body to allow the selective combination of flows associated with the uninterruptible and interruptible flow paths to manipulate the spray pattern generated by the nozzle assembly.

### FIELD OF THE INVENTION

The present invention relates generally to pressure washer systems, and in particular, to a nozzle assembly capable of generating various spray patterns when used with such devices.

### BACKGROUND OF THE INVENTION

Pressure washers generally include a motor or engine that is operatively connected to a water pump. A high pressure hose connects a wand to a discharge side of the water pump. The wand commonly includes a pistol grip or the like that includes a trigger whose actuation effects discharge of a high-pressure water stream from the nozzle. Both the simplicity of operation and effectiveness associated with using such devices has made pressure washers a staple for various residential and commercial cleaning and surface preparation tasks.

Understandably, many cleaning and surface preparation operations are best carried out with the use of extraneous cleaning or surface treatment agents and/or manipulation of the spray pattern associated with operation of the pressure washer. For instance, some surface cleaning or preparation activities are more easily performed with a more centralized or unitary stream of water whereas other cleaning or surface preparation operations can be best performed with a fan or cone spray stream wherein the water stream is aligned along an axis or emanates from the wand in more conical shape, respectively. To better effectuate the desired cleaning or surface preparation operations, many power washers are configured for use with interchangeable or replaceable nozzles that are each configured to removably cooperate with the discharge end of the wand. Such systems commonly require that a number of discrete nozzle assemblies be provided and maintained to generate the desired spray pattern. The size of such nozzle assemblies renders them susceptible to loss or misplacement thereby requiring that the user to replace lost or misplaced nozzles if the spray pattern associated with the nozzle is needed for a desired cleaning or treatment operation.

Recognizing such a shortcoming, others provide adjustable nozzle assemblies that can be constructed to cooperate with the discharge end of a wand. Such nozzle assemblies can be configured to removably cooperate with the wand in a tool-less manner or be configured to more rigidly cooperate with the wand such that one or more tools are required to manipulate cooperation of the nozzle assembly with the wand. Many such adjustable nozzle assemblies include a control or dial that is associated with the nozzle assembly. The control or dial is commonly configured to be rotatable about an axis that is perpendicular to or normal to the direction of the fluid flow. Other adjustable spray nozzle assemblies include a plurality of discrete nozzles orifices that each has unique shapes associated with generating a desired spray pattern when the respective orifice is aligned with the fluid flow through the wand. Such adjustable spray pattern nozzle assemblies can suffer from a number of drawbacks.

Such nozzle assemblies must commonly be provided with a number of seals that prevent water from being allowed to exit the nozzle assembly at the orifice of unused nozzles or along paths associated with the interface of the control with the fluid path or a support portion of the nozzle assembly. Such nozzle assemblies must also commonly include fairly tight manufacturing tolerances between the parts of the nozzle assembly that are intended to be moveable and require the formation of various parts of materials that are capable of withstanding the operating conditions associated with use of the respective nozzle assembly.

Some such nozzle assemblies are also generally considerably larger than nozzles with singular orifice openings. That is, the various orifice openings are commonly circumferentially positioned about a rotational control body so that only one respective orifice is aligned with the fluid passage associated with the wand at any given time. The unused orifice openings are generally circumferentially spaced relative to an axis of rotation of the control body so that each discrete orifice can be selectively aligned with an in-use position of the orifice relative to the underlying nozzle assembly. The circumferential spacing of the various orifices dramatically increases the footprint or size of the overall nozzle assembly. Further, although such nozzle assemblies provide various spray patterns, the variability of the spray pattern is more so associated with the relative positioning of a given orifice shape in the fluid flow rather than any manipulation of the respective orifice shapes and/or the amount of fluid flow that is allowed to pass through the nozzle assembly.

Therefore, there is a need for a pressure washer adjustable nozzle assembly that is convenient to manufacture and use, can be provided in a compact form factor, and is operable with an underlying pressure or power washer system to provide various different spray patterns.

### SUMMARY OF THE INVENTION

The present invention provides a nozzle assembly and method of forming an adjustable spray pattern nozzle assembly for use with pressure washing systems that overcomes one or more of the drawbacks mentioned above. One aspect of the invention discloses a nozzle assembly that includes a mount body, a nozzle body, and a collar that movably cooperates with the mount body. The mount body is constructed to cooperate with a discharge end of a wand such that the nozzle body can be captured between the mount body and the collar. The nozzle body defines an uninterruptible fluid flow path through the nozzle assembly. The nozzle assembly includes an interruptible fluid flow path that is defined by a positional relationship between the nozzle body and the collar. The collar movably cooperates with the mount body to allow the selective contribution of a flow associated with the interruptible flow path with a flow associated with the uninterruptible flow path. The selective combination of the interruptible flow with the uninterruptible flow allows the nozzle assembly to generate multiple different spray patterns without dissociating the nozzle assembly from the wand.

Another aspect of the invention that is useable with one or more of the above aspects discloses a pressure washer nozzle assembly having a base that cooperates with a discharge end of a wand. A nozzle is associated with the discharge end of the wand and arranged to direct a fluid flow passed through the wand to atmosphere in a spray pattern. The nozzle defines a first fluid path that is aligned with a longitudinal axis of the nozzle. The nozzle includes a port that extends in a radial direction through the nozzle. A collar is engaged with the base and substantially surrounds the nozzle. The collar defines a discharge opening of the nozzle assembly and cooperates with the nozzle to define a second fluid path that is between the collar and the nozzle. The second fluid path is configured to selectively communicate a fluid flow from the port to the discharge opening of the nozzle assembly. The collar cooperates with the base and is movable between a first axial position associated with suspending communication of the fluid flow associated with the second fluid path to the discharge opening and a second axial position associated with fluidly connecting the second fluid path to the discharge opening of the collar.

Another aspect of the invention that is useable with one or more of the above aspects discloses an adjustable spray nozzle assembly that includes a mount body that is securable to a discharge end of a wand. A nozzle body is aligned with a longitudinal passage defined by the wand and a fluid passage that is defined by an interior surface of the nozzle body is aligned with the longitudinal passage defined by the wand. A collar is engaged with the mount body and is rotatable relative thereto. A discharge opening is formed in the collar and is aligned with the first fluid passage of the nozzle body. A seal face is formed on a radially interior surface of the collar proximate the discharge opening of the collar. The seal face is further defined as being axially movable relative to the nozzle body upon rotation of the collar between a contact engagement with the nozzle body and an offset position from the nozzle body such that only fluid associated with the fluid passage passes through the discharge opening when the seal face is in contact engagement with the nozzle body and such that fluid associated with the fluid passage and fluid that passes between the collar and the nozzle body passes through the discharge opening of the collar when the seal face is at the offset position relative to the nozzle body.

Another aspect of the invention that is useable with one or more of the above aspects discloses a method of forming an adjustable nozzle assembly for generating multiple spray patterns. The method includes providing a nozzle assembly mount that is configured to cooperate with a wand that is connectable to a pressure washer. A nozzle body is provided that defines an uninterruptible fluid passage that extends in an axial direction through the nozzle body. A spray adjustment body is provided that movably cooperates with the nozzle mount assembly and defines a spray outlet that is aligned with the uninterruptible fluid passage. An adjustment interface is provided between the spray adjustment body and the nozzle mount assembly and is configured to accommodate rotational and axial translation of the spray adjustment body relative to the nozzle mount assembly to manipulate a size of a cross-section associated with an interruptible fluid passage defined by an interior surface of the spray adjustment body and an exterior surface of the nozzle body to allow selective combination of different fluid flows associated with the interruptible fluid passage with fluid flow attributable to the uninterruptible fluid passage.

Other aspects, features, and advantages of the invention will become apparent to those skilled in the art from the following detailed description and accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

The drawings illustrate the best mode presently contemplated of carrying out the invention.

In the drawings:

FIG. 1 is a perspective view of a portable engine powered pressure washing device equipped with a variable spray pattern nozzle assembly according to the present invention;

FIG. 2 is a detailed perspective view of the nozzle assembly shown in FIG. 1;

FIG. 3 is an exploded view of the nozzle assembly shown in FIG. 2 and removed from the wand;

FIG. 4 is a cross-sectional view of the assembled nozzle assembly shown in FIG. 2 and taken along longitudinal centerline 4-4 of the assembly with a movable collar in a first axial position relative to a nozzle body and a base of the nozzle assembly; and

FIG. 5 is a view similar to FIG. 4 and shows the movable collar in a second axial position relative to the nozzle body and base.

### DETAILED DESCRIPTION OF THE DRAWINGS

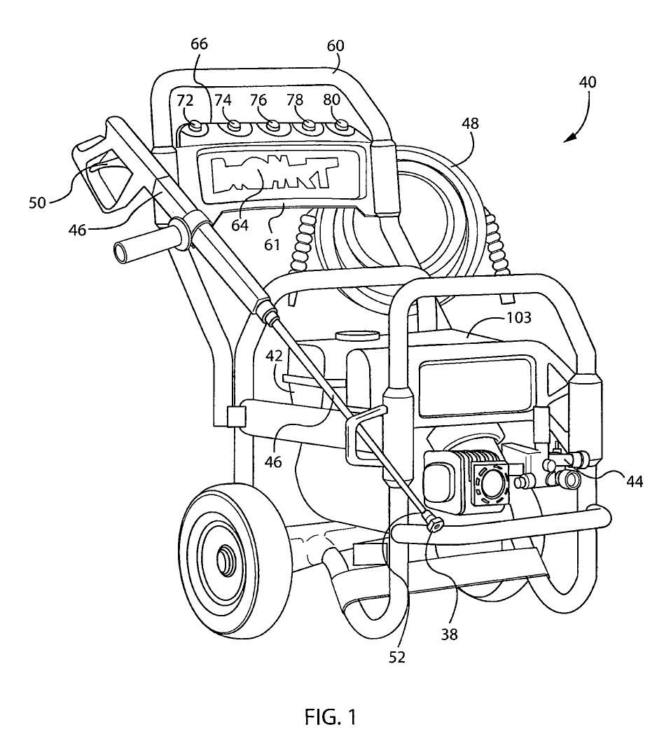

FIG. 1 shows an adjustable spray pattern nozzle or nozzle assembly 38 according to the present invention connected to a portable engine powered pressure washer 40. As shown in FIG. 1, pressure washer 40 includes an internal combustion engine 42 that is operationally connected to a pump 44. It is appreciated that the nozzle assembly 38 according to the present invention is usable with many underlying power or pressure washer systems, including those having an engine or a motor driven pump as well as less portable pressure washing systems. Those skilled in the art will readily appreciate the various alternative configurations of a power washing system usable with nozzle assembly 38 according to the present application.

With respect to pressure washer 40, engine 42 can be directly or indirectly (via a power transmission system such as a belt or other flexible drive member) coupled to pump 44. When engine 42 directly cooperates with pump 44 without supplemental power transmission systems, pump 44 can be considered a direct drive pump. It is appreciated that there a number of methodologies associated with generating a desired fluid pressure output associated with use of pressure washer 40. One methodology includes providing a pressure output of the pump that is a function of the operational revolutions per minute (rpm) of the pump and which is directly correlated to the operating speed or revolutions per minute (rpm) of the engine crankshaft. The higher the rpm of the pump, the higher the pump output pressure-assuming other system variables to be constant. In such a confirmation, the input rpm of the pump is controlled by the engine rpm by means of controlling the engine throttle such that, variable pressures can be provided at the pump output pressure via manipulation of the engine throttle or engine speed. Alternatively, it is appreciated that the pressure output of pump 44 may be manipulated by a regulator as disclosed below. The variable pressure pump output in conjunction with an engine speed or pump pressure selector dial allows one pressure washer to act as though it were capable of providing several different fixed operating pressures.

As alluded to above, another methodology for manipulating the pump discharge pressure delivered to the wand includes providing a variable setting regulator or bypass valve assembly associated with operation of the pump. Such a configuration includes a valve assembly that is integral to the pump or disposed between pump 44 and a wand 46 for communicating the pressurized fluid flow to wand 46 connected to pump 44. As explained further below, the valve assembly provides a control or regulator associated with regulating the pressure flow communicated to the wand in a manner partially independent of engine operating speed. That is, such a regulator allows the delivery of fluid to wand 46 at variable pressures at or below a maximum output pressure associated with the available water source pressure and given operating conditions of engine 42.

Still referring to FIG. 1, wand 46 is connected to an output side of pump 44 via a hose 48. A trigger 50 is supported by wand 46 and is located at one end of wand 46. Nozzle assembly 38 is connected to a discharge end 52 of wand 46. Pressure washer 40 preferably includes a chassis 54 having one or more wheels 56 and a handle 60 for improving the mobility of the unit to facilitate convenient transportation of pressure washer 40. It is appreciated that nozzle assembly 38 is usable with other less mobile pressure washing systems.

Discharge end 52 of wand 46 is commonly associated with an end of wand 46 that is opposite trigger 50. Discharge end 52 of wand 46 is constructed to cooperate with nozzle assembly 38 to allow the fluid flow communicated via wand 46 to be directed through nozzle assembly 38. Nozzle assembly 38 is configured to removably cooperate with wand 46 via one or more threaded or otherwise selectively severable connection methodologies that can either provide a tool-less interaction or a tool operable interaction between nozzle assembly 38 and wand 46. It is appreciated that various such tool requiring and tool-less interactions are feasible as both provide a secure connection between nozzle assembly 38 and wand 46.

It is further appreciated that pressure washer 40 can be provided with and is usable with other alternate or replacement nozzles or nozzle assemblies that can be engaged with wand 46 when nozzle assembly 38 is removed therefrom. Preferably, such replacement nozzle assemblies cooperate with wand 46 in the same manner as nozzle assembly 38 and are configured to provide spray patterns and/or soaping and/or foaming functions associated with alternate uses of pressure washer 40. As explained further below, nozzle assembly 38 is configured to provide various spray patterns but it is appreciated that pressure washer 40 may have an operating range that extends beyond a range of operation associated with use of nozzle assembly 38. It is appreciated that nozzle assembly 38 can be configured to cooperate with wand 46 in a tool-less manner or in a manner that would require one or more tools to effectuate separation of nozzle assembly 38 from wand 46 as explained above for alternate uses of pressure washer 40 or use of pressure washer 40 with nozzles or nozzle assemblies having other functionality.

Pressure washer 40 can include a panel, bezel, or dashboard 61 that can include one or more instructional indicia 64 associated with the desired operation or intended use of pressure washer 40. Preferably, dashboard 61 includes one or more indicia that explain, either textually or pictographically, proper operation of pressure washer 40. It is also appreciated that dashboard 61 can include one or more receptacles or mounting portions 66 associated with supporting replaceable or interchangeable tips, nozzles, or nozzle assemblies 72, 74, 76, 78, 80 associated with alternate uses of pressure washer 40 beyond the operating capabilities of nozzle assembly 38 and/or a replacement nozzle assembly 38 should the in-use nozzle assembly be somehow rendered inoperable. Preferably, aside from foaming operations, nozzle assembly 38 is configured to provide alternate spray patterns across the range of operation of pressure washer 40. As alluded to above, nozzles 72-80 are configured to interchangeably cooperate with discharge end 52 of wand 46 so as to replace nozzle assembly 38 thereby allowing use of pressure washer 40 for other uses, such as soap, foaming, cleaning, or treatment agent application operations.

It is also appreciated that one more of nozzles 72, 74, 76, 78, 80 could have a construction similar to—but preferably different than—nozzle assembly 38. It is envisioned that such a nozzle assembly and/or the providing of more than one nozzle assembly capable of generating various spray patterns would provide a pressure washer system with nozzles capable of providing adjustable spray patterns with a different range of spray pattern adjustment than nozzle assembly 38. Such a provision would provide a pressure washing system capable of providing a greater range of adjustment of the spray pattern as a function of an association of the range of adjustment of the nozzle assembly as it relates to a range of operation of the underlying pressure washer device.

It is further appreciated that wand 46 or pressure washer 40 can include a treatment agent introduction system 103 for introducing a cleaning or treatment agent to the fluid flow delivered to wand 46 via hose 48. It is appreciated that agent introduction system 103 could be configured to introduce such a treatment agent to the feed water stream at a low pressure or a high pressure side of pump 44, prior to delivery of the operating fluid to wand 46, immediately prior to the introduction of the operating fluid stream to nozzle assembly 38 at discharge end 52 of wand 46, and/or downstream of nozzle assembly 38. It is further appreciated that although agent introduction system 103 is shown as being supported proximate engine 42 and pump 44 associated with chassis 54, agent introduction system 103 could be associated with hose 48 and/or supported and/or integrated with wand 46. Regardless of the specific location of agent introduction system 103, each such configuration further increases the functionality of pressure washer 40 whether utilized with nozzle assembly 38 or another nozzle assembly 72-80.

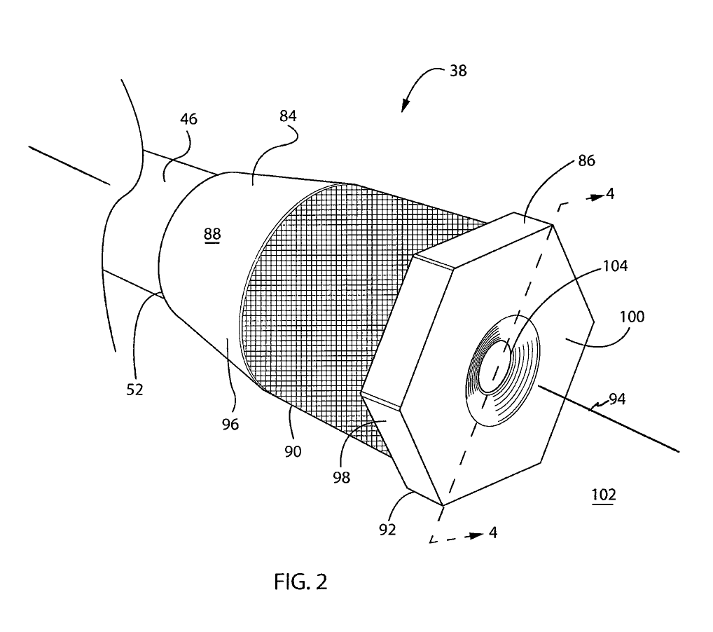

FIG. 2 is a detailed perspective view of nozzle assembly 38 engaged with discharge end 52 of wand 46. A mount body, nozzle assembly mount, or base 84 is disposed at discharge end 52 of wand 46. Base 84 can be positionally fixed or otherwise permanently secured to wand 46, configured to rotatably cooperate with wand 46 in a sealed manner, or be provided in a quick-connect methodology configured to allow the tool-less connection of nozzle assembly 38 with wand 46. It is appreciated that when provided in a rotatable configuration, an outer radial surface 88 of base 84 can be constructed to cooperate with a tool and/or to be gripped by a user to facilitate rotation of collar 86 relative to discharge end 52 of wand 46. Understandably, if base 84 is fixedly secured to wand 46, surface 88 may be provided with a generally smoother or curvilinear surface as tooled or grippable interaction with base 84 would be rendered unnecessary.

A spray adjustment body or collar 86 rotatably cooperates with base 84 and is configured to manipulate the spray pattern delivered by nozzle assembly 38. Collar 86 includes a first portion 90 and the second portion 92 that extend along a longitudinal axis, indicated by line 94, of nozzle assembly 38. First portion 90 of collar 86 includes a threaded section 96 having a number of threads 97 that threadably cooperates with base 84. An outer radial surface 98 of second portion 92 of collar 86 is preferably shaped to be gripped by a user to allow rotation of collar 86 relative to base 84. Collar 86 includes an end face 100 that is opposite wand 46 and exposed to atmosphere 102.

A spray output or discharge opening 104 is associated with end face 100 and extends through collar 86 generally along axis 94. During delivery of a fluid stream or flow associated with operation of pressure washer 40 to nozzle assembly 38, all the fluid communicated to nozzle assembly 38 exits nozzle assembly 38 at discharge opening 104. Said in another way, nozzle assembly 38 is capable of providing various spray patterns but includes only one discharge opening 104. Rotational manipulation of collar 86 relative to base 84 yields axial translation of collar 86 relative to base 84 and manipulates the spray pattern associated with discharge opening 104.

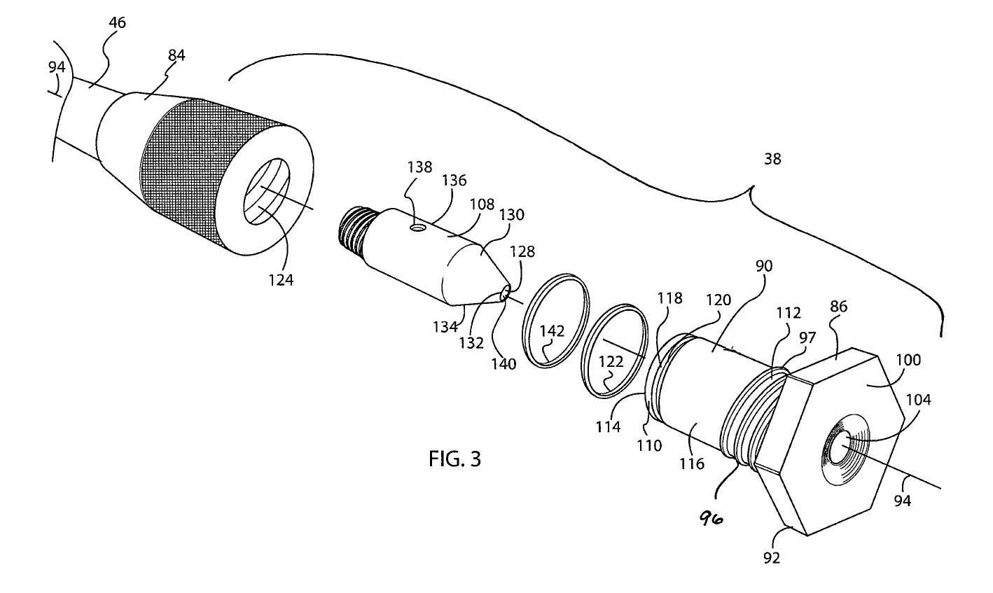

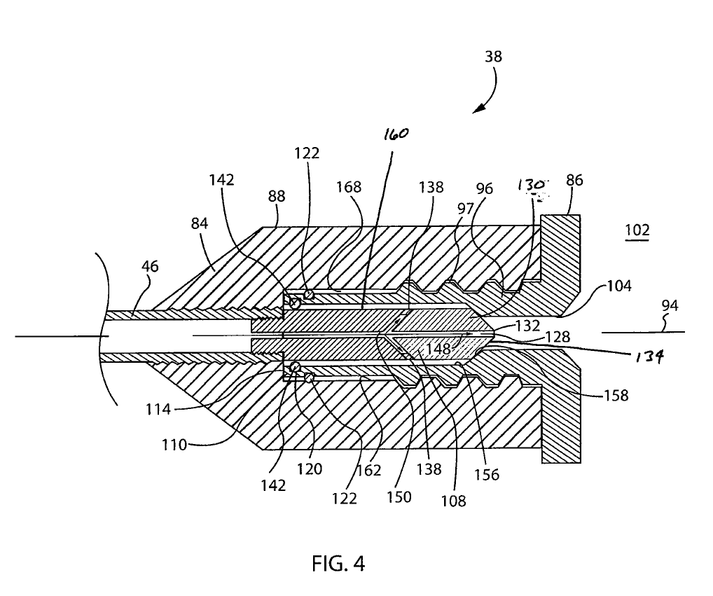

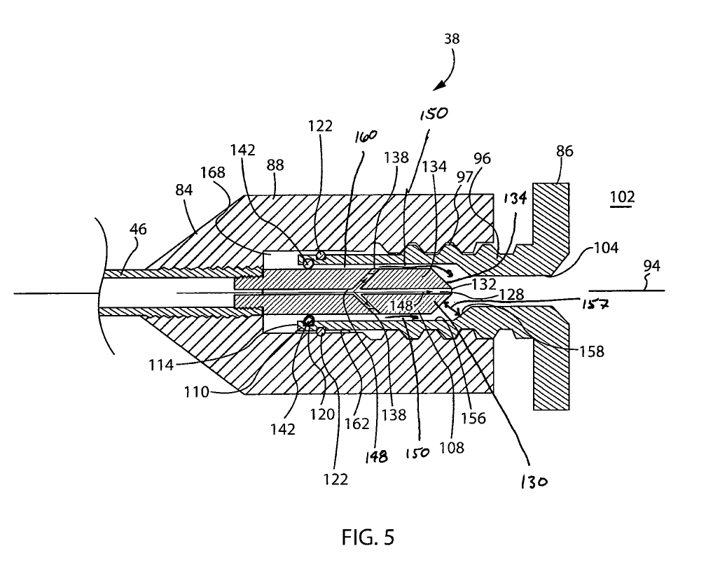

FIG. 3 shows collar 86 removed from base 84 and exposes a nozzle or nozzle body 108 that is captured generally radially and axially between base 84 and collar 86. First portion 90 of collar 86 includes a first section 110 and a second section 112 that are axially offset from one another along the longitudinal length of collar 86. Second section 112 is generally defined as including threading 97 associated with the rotational cooperation of collar 86 with base 84. First section 110 extends from a first end 114 of collar 86 to an interface 116 associated with upstream termination of threading 97. An outer radial surface 118 of first section 110 is generally smooth aside from a channel or groove 120 that is formed in first section 110 of collar 86. Groove 120 is shaped to receive a gasket or seal 122 that extends beyond the exterior radial surface 118 associated with first section 110 of collar 86. When disposed in groove 120, seal 122 extends proud of surface 118 and slidingly and sealingly cooperates with an interior radial surface 124 of base 84 as described further below with respect to FIGS. 4 and 5.

Still referring to FIG. 3, nozzle body 108 extends in a longitudinal direction along axis 94 and is generally radially surrounded by base 84. Nozzle body 108 includes a passage 128 that extends longitudinally through nozzle body 108 generally along axis 94. Nozzle body 108 includes an end portion 130 that tapers in an upstream radial direction with respect to an upstream direction along longitudinal axis 94 from an outlet end or nozzle outlet 132 associated with passage 128 of nozzle body 108. The taper of end portion 130 defines a contact surface or face 134 that extends in an elongated radial direction between nozzle outlet 132 and an outer radial surface 136 of nozzle body 108. As explained further below with respect to FIGS. 4 and 5, contact face 134 is shaped to cooperate with an internal radial surface of collar 86 to manipulate a cross-sectional shape of an interruptible fluid path through nozzle assembly.

Still referring to FIG. 3, a number of bypass ports or ports 138 extend in a radial direction through nozzle body 108 between outer radial surface 136 and an inner radial surface 140 of nozzle body 108 that defines fluid passage 128. Preferably, ports 138 are equidistantly spaced about the circumference of nozzle body 108 and are canted or otherwise pitched in a direction aligned with the direction of fluid flow through nozzle body 108 as the ports extend from passage 128 toward the outer radial surface of nozzle body 108. Nozzle body 108 can be constructed to be fixedly secured to wand 46 or be configured to be removable therefrom. It is further appreciated that any number and size of ports 138 can be provided to achieve a desired flow characteristic through nozzle assembly 38 across the various positions associated with the movable interaction of collar 86 with base 84 and nozzle body 108 of nozzle assembly 38.

A second gasket or seal 142 slidably cooperates with nozzle body 108. Nozzle body 108 and base 84 are shaped to allow seal 142 to be disposed at a location that is upstream of ports 138. As explained further below with respect to FIGS. 4 and 5, seals 122, 142 provide a sealed interaction of end 114 of collar 86 with base 84 and nozzle body 108 throughout the range of rotational and axial motion of collar 86 relative to base 84 and nozzle body 108 such that any fluid delivered to nozzle assembly 38 exits nozzle assembly 38 at discharge opening 104 of collar 86 rather than via the interfaces of wand 46, base 84, collar 86, nozzle body 108 with adjacent structures.

FIGS. 4 and 5 are both cross section views of nozzle assembly 38 along longitudinal axis 94 of nozzle assembly 38 associated with line 4-4 shown in FIG. 2. FIG. 4 shows collar 86 in a first axial position relative to base 84 and nozzle body 108 and FIG. 5 shows collar 86 in a second axial position relative to base 84 and nozzle body 108. As explained further below, when collar 86 is oriented in the first axial position (FIG. 4), only fluid associated with a first or uninterruptable fluid flow passage or path 148 associated with passage 128 of nozzle body 108 is allowed to pass through discharge opening 104 of collar 86. When collar 86 is offset or axially spaced from nozzle body 108 (FIG. 5), fluid flow associated with a second or selectively interruptible fluid path 150 is allowed to combine with the fluid flow associated with the uninterruptible fluid path 148 proximate discharge opening 104 of collar 86 and manipulates the spray pattern delivered to atmosphere 102 from nozzle assembly 38. As explained further below, the infinitely incremental adjustability of collar 86 relative to nozzle body 108 allows nozzle assembly 38 to provide a variety of spray patterns as collar 86 is rotated, and thereby axially translated, relative to nozzle body 108.

Still referring to FIGS. 4 and 5, a radially interior surface 156 of collar 86 includes a seal face or ridge 158 that extends at least in part in an inward radial direction toward centerline 94. The contour of ridge 158 preferably matches the contour of tapered contact face 134 of nozzle body 108. Axial displacement of collar 86 relative to nozzle body 108, effectuated by rotation or collar 86 relative to base 84, allows ridge 158 to move into and out of abutting engagement with tapered contact face 134 of nozzle body 108. That is, manipulation of collar 86 relative to base 84 and nozzle body 108 provides a variable cross-sectional spacing 157 between ridge 158 of collar 86 and tapered contact face 134 of nozzle body 108.

A space or a gap 160 is formed between a portion of radially interior surface 156 of collar 86 and a portion of outer radial surface 136 of nozzle body 108. Gap 160 extends in an axial direction along outer radial surface 136 of nozzle body 108 between ports 138 and the tapered contact face 134 of nozzle body 108. Ports 138 fluidly connect radially interior passage 128 of nozzle body 108 with gap 160 and allow a portion of the flow associated with uninterruptible fluid path 148 to be directed through gap 160 and toward the interface between ridge 158 and tapered contact face 134 such that fluid is present in gap 160 during operation of pressure washer 40 but the variable flow of fluid through gap 160 is controlled by the spatial interaction of collar 86 with nozzle body 108.

Seal 142 is disposed upstream of ports 138 and is shaped the slidably cooperate with an end portion of radially interior surface 156 of collar 86. Seal 122 seats in groove 120 of collar 86 and slidably cooperates with a radially internal facing surface 162 of base 84. Said in another way, seal 122 provides a sealed but rotationally and axially slidable interaction between collar 86 and base 84 and seal 142 provides a similar interaction between collar 86 and nozzle body 108. Seals 122, 142 cooperate with nozzle body 108 and base 84, respectively, and collar 86 to provide a sealed interaction of collar 86 with nozzle body 108 and base 84 throughout the range of relative rotational and axial translation of collar 86. A gap or cavity 168 is formed between radially internal facing surface 162 of base 84 and an outer radially facing surface nozzle body 108 to accommodate the axial translation of collar 86 relative to base 84 and nozzle body 108 so that seal 122 does not interfere with the threaded interaction between collar 86 and base 84 and seal 142 does not interfere with ports 138 of nozzle body 108. It is appreciated that seals 122, 142 could be supported by either of base 84, collar 86, and nozzle body 108 to provide the sealed interaction between the movable components of nozzle assembly 38.

The threaded cooperation between base 84 and collar 86 provides an adjustable interface of nozzle assembly 38 that allows the selective interruption of interruptible fluid path 150 and allows the fluid flow associated with the interruptible fluid path 150 to be varied or otherwise adjusted such that different fluid flows associated with interruptible fluid path 150 can be contributed or combined with uninterruptible fluid flow path 148 at a location proximate discharge opening 104 of collar 86. Preferably, the fluid flows associated with paths 148 and 150 combine with one another at a location that is upstream of discharge opening 104 relative to the direction of fluid flow through nozzle assembly 38. Collar 86 cooperates with base 84 and nozzle body 108 such that the fluid flow associated with path 150 can be fully interrupted such that fluid attributable to ports 138 and gap 160 can be selectively separated from the fluid flow associated with uninterruptible path 148 associated with passage 128 of nozzle body 108.

When oriented in the configuration shown in FIG. 4, the contacting engagement between ridge 158 and tapered contact face 134 prevents contribution of fluid flow associated with interruptible fluid path 150 with the fluid flow associated with the uninterruptible fluid path 148. As shown in FIG. 5, when collar 86 is translated away from the contacting engagement shown in FIG. 4 and toward the second axial position, ridge 158 remains spaced from or out of contact engagement with tapered contact surface or face 134 of nozzle body 108 such that fluid associated with interruptible fluid path 150 is allowed to combine with the fluid flow associated with uninterruptible fluid flow path or passage 148 thereby manipulating the fluid spray pattern dispelled from nozzle assembly 38 at discharge opening 104 of collar 86. Manipulation of collar 86 relative to base 84 from the first axial or closed orientation, as shown in FIG. 4, to the second axial or full open orientation, as shown in FIG. 5, allows nozzle assembly 38 to provide a variety of spray patterns and flow conditions across the range of motion of collar 86 and in a manner that can modify or manipulate, but does not inhibit, the flow and thereby the spray pattern, associated with the uninterruptable flow path 148. More simply said in another way, rotation of collar 86 relative to base 84 and nozzle body 108 manipulates the spray pattern delivered by nozzle assembly 38 by manipulating the contribution of an interruptible fluid flow which can interact with an uninterruptable fluid flow.

Many changes and modifications could be made to the invention without departing from the spirit thereof. The scope of these changes will become apparent from the appended claims.

What we claim is:

1. A pressure washer nozzle assembly comprising:
a base that cooperates with a discharge end of a wand;
a nozzle associated with the discharge end of the wand and arranged to direct a fluid flow passed through the wand to atmosphere in a spray pattern, the nozzle defining a first fluid path aligned with a longitudinal axis of the nozzle;
a port that extends in a radial direction through the nozzle;
a collar engaged with the base and substantially surrounding the nozzle, the collar defining a discharge opening of the nozzle assembly and cooperating with the nozzle to define a second fluid path that is between the collar and the nozzle, the second fluid path being configured to selectively communicate a fluid flow from the port to the discharge opening of the nozzle assembly; and
wherein the collar cooperates with the base to be movable between a first axial position associated with suspending communication of fluid along the second fluid path to the discharge opening and a second axial position associated with fluidly connecting the second fluid path to the discharge opening of the collar.

2. The pressure washer nozzle assembly of claim 1 wherein the collar further comprises a ridge that contacts an end portion of the nozzle when the collar is in the first axial position and is spaced from the end portion of the nozzle when the collar is in second axial position.

3. The pressure washer nozzle assembly of claim 2 wherein rotation of the collar relative to the base manipulates a distance between the end portion of the nozzle and the ridge of the collar and thereby manipulates the spray pattern dispelled from the discharge opening.

4. The pressure washer nozzle assembly of claim 1 wherein the port is further defined as a plurality of ports that each extend in a radial direction through the nozzle and each of the plurality of ports are circumferentially spaced about the nozzle and positioned upstream of an outlet end of the nozzle.

5. The pressure washer nozzle assembly of claim 1 wherein the first fluid path is connected to atmosphere when the collar is at and between the first and second axial positions.

6. The pressure washer nozzle assembly of claim 1 wherein the base cooperates with the nozzle to define a cavity between the base and the nozzle that is upstream of the port, the cavity being shaped to accommodate an end of the collar when the collar is in the first axial position.

7. The pressure washer nozzle assembly of claim 6 further comprising at least one seal disposed between at least one of the base and the collar or the collar and the nozzle.

8. An adjustable spray nozzle assembly comprising:
a mount body that is securable to a discharge end of a wand;
a nozzle body aligned with a longitudinal passage defined by the wand, a fluid passage defined by an interior surface of the nozzle body and aligned with the longitudinal passage defined by the wand;
a collar engaged with the mount body, the collar being rotatable relative to the mount body, a discharge opening formed in the collar and aligned with the fluid passage defined by the interior surface of the nozzle body; and
a seal face formed on a radially interior surface of the collar proximate the discharge opening, the seal face being axially movable relative to the nozzle body upon rotation of the collar between a contact engagement with the nozzle body and an offset position from the nozzle body such that only fluid associated with the fluid passage passes through the discharge opening when the seal face is in the contact engagement with the nozzle body and fluid associated with the fluid passage and fluid that passes between the collar and the nozzle body passes through the discharge opening of the collar when the seal face is at the offset position relative to the nozzle body.

9. The adjustable spray nozzle assembly of claim 8 further comprising a port that extends in a radial direction through the nozzle body.

10. The adjustable spray nozzle assembly of claim 9 wherein the port is further defined as a plurality of ports that each extend in a radial direction through the nozzle body and are equidistantly spaced about a circumference of the nozzle location at an axial location that is upstream of an outlet of the nozzle body.

11. The adjustable spray nozzle assembly of claim 8 further comprising at least one seal that is disposed between the collar and at least one of the nozzle body and the mount body.

12. The adjustable spray nozzle assembly of claim 11 further comprising another seal that is disposed between the collar and the other of the at least one of the nozzle body and the mount body.

13. The adjustable spray nozzle assembly of claim 8 further comprising wherein an interior facing surface of the mount body includes a threaded portion and an exterior facing surface of the collar includes a threaded portion that rotatably cooperates with the threaded portion of the mount body to manipulate an axial position of the seal face of the collar relative to the nozzle body.

14. The adjustable spray nozzle assembly of claim 13 wherein the collar includes an interior facing surface that is defined by a radius that is larger than a radius associated with an exterior surface of the nozzle body to define a gap that extends in an axial direction between the interior facing surface of the collar and the exterior surface of the nozzle body.

15. A method of forming an adjustable nozzle assembly for generating multiple spray patterns, the method comprising:
providing a nozzle assembly mount configured to cooperate with a wand connectable to a pressure washer;
providing a nozzle body that defines an uninterruptible fluid passage that extends in an axial direction through the nozzle body;
providing a spray adjustment body that movably cooperates with the nozzle mount assembly, the spray adjustment body defining a spray outlet that is aligned with the uninterruptible fluid passage; and
providing an adjustment interface between the spray adjustment body and the nozzle mount assembly, the adjustment interface being configured to accommodate rotational and axial translation of the spray adjustment body relative to the nozzle mount assembly to manipulate a size of a cross-section associated with an interruptible fluid passage defined by an interior surface of the spray adjustment body and an exterior surface of the nozzle body to allow selective combination of different fluid flows associated with the interruptible fluid passage with fluid flow attributable to the uninterruptible fluid passage.

16. The method of claim 15 further comprising providing a contact engagement between an interior surface of the spray adjustment body and the nozzle body when no fluid flow is to be combined with the uninterruptible fluid flow.

17. The method of claim 15 wherein the spray outlet of the spray adjustment body is the only fluid connection of the adjustable nozzle assembly and atmosphere.

18. The method of claim 15 further comprising providing a seal between the spray adjustment body and at least one of the nozzle body and the nozzle assembly mount.

19. The method of claim 18 further comprising providing another seal between the spray adjustment body and the other of the at least one of the nozzle body and the nozzle assembly mount.

20. The method of claim 15 further comprising forming a bypass port through the nozzle body that fluidly connects the uninterruptible fluid passage to a space defined between the nozzle body and the spray adjustment body.
